(19) United States
(12) Patent Application Publication
(10) Pub. No.: US 2017/0161739 A1
(43) Pub. Date: Jun. 8, 2017

(54) SYSTEM AND METHOD FOR TRANSACTING VIA TWO-PARTY MODEL

(71) Applicant: MasterCard International Incorporated, Purchase, NY (US)

(72) Inventors: Amit Kumar Singh, Agra (IN); Anshul Pandey, Gurgaon (IN)

(21) Appl. No.: 14/956,929

(22) Filed: Dec. 2, 2015

(51) Int. Cl. G06Q 20/40; G06Q 20/10; G06Q 20/32; G06Q 20/38

(52) U.S. Cl. CPC G06Q 20/401; G06Q 20/389; G06Q 20/38215; G06Q 20/105; G06Q 20/409; G06Q 20/32; G06Q 20/1085; G06Q 2220/00

(57) ABSTRACT

A method of operating a payment device includes interfacing the payment device to a merchant device to perform a payment transaction. The payment device may create and store a record of the payment transaction. On an occasion later than the payment transaction, the payment device may be interfaced to a network device. While the payment device is interfaced to the network device, at least a portion of the payment transaction record is transmitted from the payment device to the network device to cause the payment transaction to be cleared from the payment device user's account to the account of the merchant that operated the merchant device.

### BACKGROUND

Payment devices such as payment cards are in wide-spread use. Increasingly, payment cards are embodied as IC (integrated circuit) cards, also referred to as “smartcards”. Payment IC cards are capable of sophisticated processing, including cryptographic processing to enhance the security of the payment system.

Payment devices are also now sometimes embodied in smartphones or other mobile devices. For example, a smartphone may be programmed (with a suitable payment application or “app”) so as to be able to emulate the functions of a payment IC card. Typically, the functioning of a payment-enabled smartphone also relies on short-range radio communication features that are built into the smartphone, possibly for the express purpose of supporting use as a payment device.

FIG. 1 is a block diagram that illustrates a conventional payment system 100 that incorporates the types of payment devices mentioned above.

The system 100 includes a conventional payment card/device 102 (which may alternatively be, for example, a payment IC card or a payment-enabled mobile device that stores a payment card account number and runs a payment app). The system 100 further includes a reader component 104 associated with a POS terminal 106. In some known manner (depending on the type of the payment card/device 102) the reader component 104 is capable of reading the payment card account number and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction. Reference numeral 107 indicates a user/account holder who is a customer at the retail store and who has presented the payment card/device 102 to the reader component in order to settle the retail transaction.

A computer 108 operated by an acquirer (acquiring financial institution; sometimes referred to as a “transaction acquirer”) is also shown as part of the system 100 in FIG. 1. The acquirer computer 108 may operate in a conventional manner to receive a payment account transaction authorization request message (sometimes referred to as an “authorization request”) for the transaction from the POS terminal 106. The acquirer computer 108 may route the authorization request via a payment network 110 to the server computer 112 operated by the issuer of a payment account that is associated with the payment card/device 102. As is also well known, the payment account transaction authorization response message (also referred to as an “authorization response”) generated by the payment account issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment card issuer server computer 112 may be operated by or on behalf of a financial institution (“FI”) that issues payment accounts to individual users and other entities. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated proximity reader components. The system may also include a very large number of payment account holders, who carry payment cards or other devices for initiating payment transactions by presenting an associated payment account number to the reader component of a POS terminal.

The transaction model illustrated in FIG. 1 includes two financial institutions, namely the acquirer 108, which is the bank for the merchant that operates the POS terminal 106, and the account issuer, which is the bank that serves the user 107. This transaction model is sometimes referred to as being a “four-party model”, with the four parties being the user, the merchant, the user's bank (payment account issuer) and the merchant's bank (transaction acquirer).

The four-party transaction model illustrated in FIG. 1 is prevalent in technologically advanced countries. One benefit it provides is nearly instantaneous online approval of transactions. However, the four-party model is generally dependent on the availability of data communications connectivity among the POS terminal 106, the acquirer 108, the payment network 110 and the issuer 112. By the same token, this model also generally assumes that the merchant's premises are served with a continuous supply of electrical power. While those conditions exist quite broadly in commercial districts in developed countries, if one considers other locations, such as in many parts of developing countries, and/or in remote areas or isolated locations in developed or middle-income countries, those conditions may not exist. Accordingly, it may not be feasible in many parts of the world to support a payment system according to the four-party model illustrated in FIG. 1. This may limit the opportunities to utilize advanced, convenient payment devices where the technological infrastructure does not exist at the merchant's location for the type of system shown in FIG. 1. Consequently, cash transactions, with their well-known costs and disadvantages, are still employed at many merchant locations outside of the “well-connected” parts of the wealthier countries.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates a payment system according to some embodiments.

FIG. 3 is a schematic plan view of a payment card according to some embodiments.

FIG. 4 is a block diagram that shows some features of the payment card of FIG. 3.

FIG. 5 is a block diagram that illustrates a merchant device according to some embodiments.

FIG. 6 is a block diagram that illustrates an automated teller machine (ATM) according to some embodiments.

FIG. 7 is a simplified block diagram that represents a network terminal according to some embodiments.

FIG. 8 is a block diagram that illustrates a typical hardware architecture for one or more computers that may be included in the payment system of FIG. 2.

FIGS. 9-13 are flow charts that illustrate processes that may be performed in the payment system of FIG. 2.

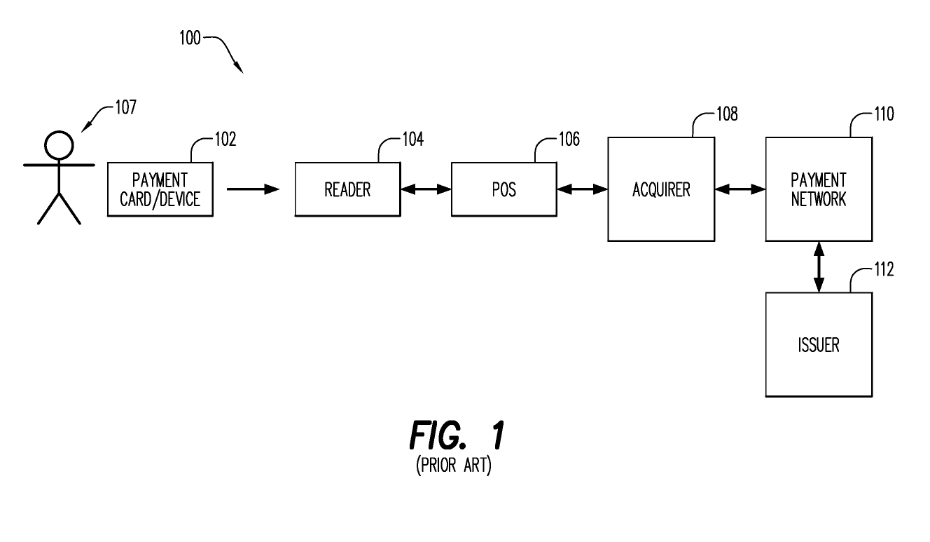

### DETAILED DESCRIPTION

In general, and to introduce concepts of embodiments of this disclosure, a payment system supports a two-party payment transaction model. The payment system may facilitate secure transactions for merchants whose transaction devices are customarily off-line. Transactions may be facilitated at locations where either or both of data communication connectivity and electric power service are absent.

During a transaction, a customer's/user's payment card/device may exchange data communications with the merchant's transaction device. Both devices may be battery-powered; alternatively, the merchant's device may be battery-powered and may supply power (e.g., by direct contact or inductively) to the user's payment device. The payment device may receive transaction information, including a transaction amount and merchant identifier, from the merchant's device. The payment device may generate and store a record for the transaction; this may include generating a transaction cryptogram over transaction-specific data such as a transaction counter value and/or a transaction identifier. The payment device may supply at least some of its transaction record, including the cryptogram, to the merchant's device.

Subsequently, the user's payment device may be interfaced (on a later occasion and at a different location) to a network-connected device such as an ATM and/or the merchant's device may be interfaced to a network-connected device or is itself connected to a data communication network (this too may be on a later occasion, and possibly at a different location). When either of these occurs, the transaction record/information, including the cryptogram, is uploaded to the respective party's bank to trigger verification of the cryptogram and clearing of the transaction between the user's account and the merchant's account.

With this approach, advanced and convenient payment devices may be employed in cashless transactions at many retail locations that have previously relied mainly or entirely on cash transactions.

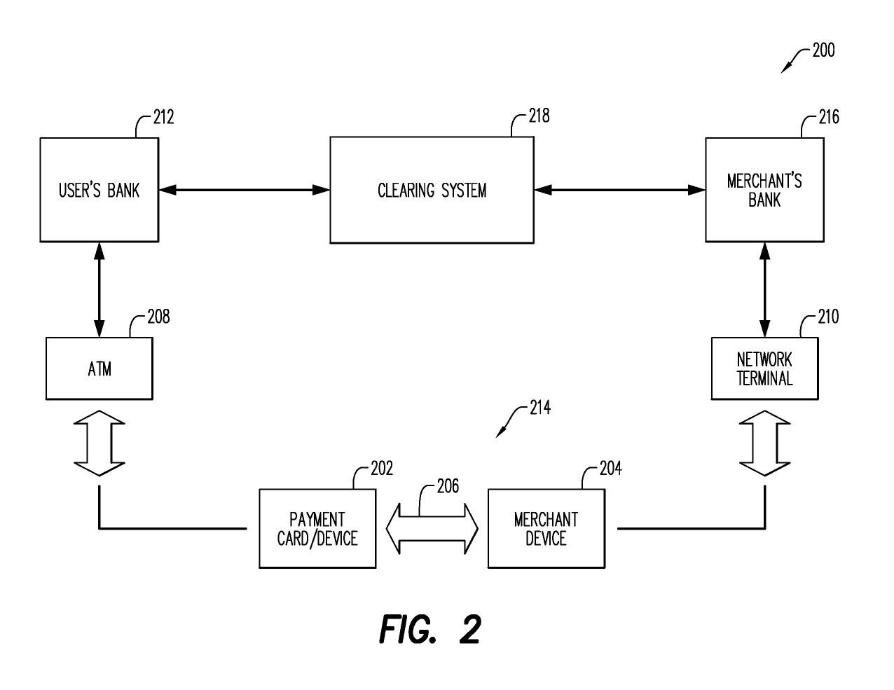

FIG. 2 is a block diagram that illustrates a payment system 200 according to some embodiments.

The payment system 200, as illustrated in FIG. 2, may include a payment card/device 202 and a merchant device (also referred to as a merchant transaction device) 204. As indicated at 206, during a transaction, the payment card/device 202 and the merchant device 204 are interfaced to each other to permit data communications therebetween. The data communication connection between the payment card/device 202 and the merchant device 204 may be via direct electrical contact connections (such as are employed in contact-type payment IC cards), or alternatively may be via short range wireless communication. In some embodiments, the merchant device 204 is battery-powered. In some embodiments, the payment card/device 202 is battery-powered as well. In some embodiments, the payment card/device 202 is powered during the transaction from the merchant device 204 by direct electrical contact or via inductive/radiated power transmission. Details of example embodiments of the payment card/device 202 and the merchant device 204 will be described below.

An ATM 208 may also be included in the payment system 200. As briefly referred to above, the ATM 208 may include functionality to allow the payment card/device 202 to report one or more transaction records in the payment system 200. Details of an example embodiment of the ATM 208 are described below.

A network terminal 210 may also be included in the payment system 200. The network terminal 210 may include functionality to allow the merchant device 204 to report one or more transaction records in the payment system 200.

During the transaction, the payment card/device 202 and the merchant's device 204 may be located at the merchant's location, such as a retail store, a market stall, etc. The ATM 208 may be located at a different place from the merchant's location. The network terminal 210 may be located at a different place from the merchant's location and at a different place from the ATM 208.

Block 212 in FIG. 2 represents a bank (and/or a computer that is operated by the bank) that issued a payment account and/or a payment card to the user/customer who participated in the transaction illustrated at 214.

Block 216 in FIG. 2 represents another bank (and/or a computer that is operated by the latter bank), where the latter bank provides banking services to the merchant who operates the merchant device 204.

Block 218 in FIG. 2 represents a clearing system, which may comprise one or more computers (not separately shown in FIG. 2). The clearing system 218 may be in data communication at least intermittently with the computers for banks 212 and 216 to facilitate clearing of transactions between accounts at the banks.

It should be understood that the payment system 200, as depicted in FIG. 2, only reflects components required for a single transaction. In a practical embodiment of the payment system 200 there may (or may not) be only one clearing system 218, but the system is likely to include a considerable number of banks that serve/maintain accounts for numerous merchants and/or users/payment account holders (i.e., the latter parties being holders/users of payment cards/devices). There may also be a considerable number of ATMs and/or network devices by which the large number of payment cards/devices and/or merchant devices may be provided—from time to time—with access/data communications connectivity to bank computers.

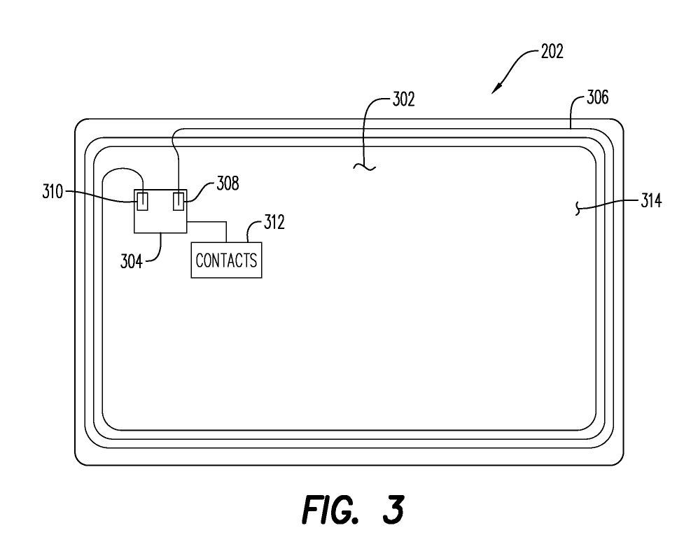

FIG. 3 is a schematic plan view of a typical example of a payment card 202 according to some embodiments.

The payment card 202 may include a card-shaped body 302, which may resemble conventional payment cards in shape and size. The card-shaped body 302 may be formed of plastic or another suitable material.

The payment card 202 may also include an IC 304. The IC 304 may be mounted and/or installed in any suitable manner in the card-shaped body 302. For example, the IC 304 may be embedded (partially or completely) in the card-shaped body 302. In some embodiments, the IC 304 may be suitably programmed to operate in accordance with the well-known EMV standard for payment transaction communications and security. In addition or alternatively, the IC 304 may be programmed to conform to one or more other payment transaction protocols.

The payment card 202 may further include an antenna 306 embedded in or otherwise mounted on the card-shaped body 302. As shown, the antenna 306 may be in the form of several loops arranged along the periphery of the card-shaped body 302. Alternatively, the antenna 306 may be of a different type and/or configuration. The antenna may be operative to receive interrogation and power signals (which may be the same signal) from a merchant device 204 and to transmit payment transaction data to the merchant device 204.

Returning to the IC 304, it will be noted that it includes terminals 308, 310 by which the IC 304 is electrically conductively connected to the antenna 306.

In addition, or as an alternative to the antenna 306 provided for contactless interaction with the merchant device 204, the payment card 202 may include a set of electrically conductive contacts (schematically represented by block 312) connected to the IC 304. In some embodiments, the contacts 312 may be provided on the front surface 314 of the card-shaped body 302, and in a pattern (not indicated in the drawing) in accordance with a standardized arrangement for electrical contacts on a payment or I.D. smartcard. The contacts 312 may permit the IC 304 to be coupled by electrically conductive signal paths (including one or more power signal paths) to the merchant device 204.

Accordingly, the payment card 202 may be a “dual use” card for either contactless or contact interfacing to a terminal, or alternatively may be configured to support only contact interfacing or only contactless interfacing

In some embodiments, lettering (not shown) or other symbols (not shown) may be present on the front surface 312 of the card-shaped body 302 and/or on the rear surface (not shown) of the card-shaped body 302. The letters and/or symbols may, for example, identify the card issuer, the brand of a payment network, etc. Other typical features of a payment card may also be present.

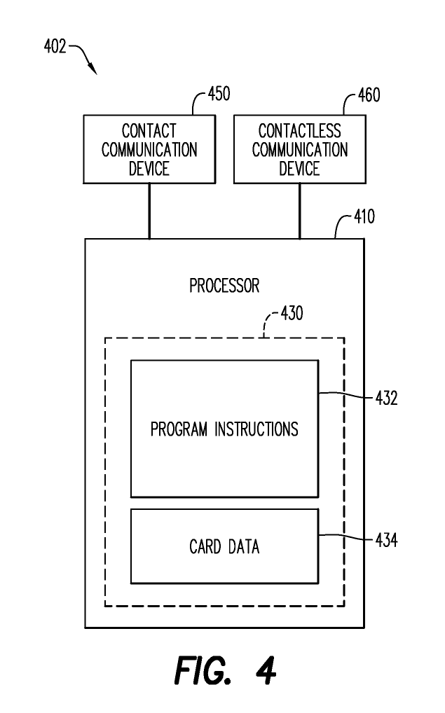

FIG. 4 is a block diagram that shows some features of the payment card 202. In particular, FIG. 4 schematically illustrates active components 402 of the payment card 202. At least portions of the active components 402 may be embodied in the IC 304 shown in FIG. 3.

Continuing to refer to FIG. 4, the payment card 202 and its active components 402 may include a processor 410, such as one or more commercially available Central Processing Units (CPUs) in the form of one-chip microprocessors, coupled to a contact communication device 450 and/or a contactless communication device 460 allowing communication between the processor 410 and, e.g., the merchant device 204 or the ATM 208. For example, contact communication device 450 may include circuitry and components allowing the payment card 202 to communicate using contact communications technologies (e.g., pursuant to ISO/IEC 7816 or the like). Similarly, the contactless communication device 460 may include circuitry and components allowing the payment card 202 to communicate using contactless communications technologies (e.g., pursuant to ISO/IEC 14443 or the like). The communication devices 450, 460 may be used to communicate, for example, with one or more remote devices (such as the user's bank's computer 212).

In some embodiments, most or all of the electronic components shown in FIG. 4 may be constituted as an EMV chip.

The processor 410 also communicates with a storage unit 430. The storage unit 430 may comprise any appropriate information storage unit, including combinations of persistent or non-persistent storage units such as semiconductor memory devices. The storage unit 430 stores program instructions 432 of various kinds, including one or more “apps” and/or software to provide functionality as described herein. Further the storage unit 430 (e.g., as constituted by an EMV chip) also may store payment card account data, as represented by block 434 in FIG. 4. The payment card account data 434 may include, for example, one or more PANs and/or payment tokens that identify or point to the payment card accounts to be accessed using the payment card 202. The PANs and/or tokens may collectively be referred to as account indicator numbers. Other data, such as cardholder name, expiration date, encryption keys, etc. customarily stored in connection with a payment function on a payment card may also be included in the payment card account data represented at 434.

The processor 410 and storage device 430 may, in some embodiments, as noted above, be constituted by an IC or “chip”, such as the IC 304 shown in FIG. 3. The storage device 430 may alternatively be referred to as a memory or (non-transitory) storage medium.

Pursuant to some embodiments, the payment card 202 also may include a battery or other power source (not shown) to allow the active components 402 to be operable even when the payment card 202 is not interfaced to/powered by another device.

While a single processor 410 is shown in FIG. 4, in some embodiments, two or more processors may be provided on the payment card 202. For example, one processor may be provided to perform standard payment chip processing, while a second processor may be provided to control other operating features of the payment card 202. In such embodiments, the second processor interacts with the first processor using an interface or communications bus (not shown in FIG. 4).

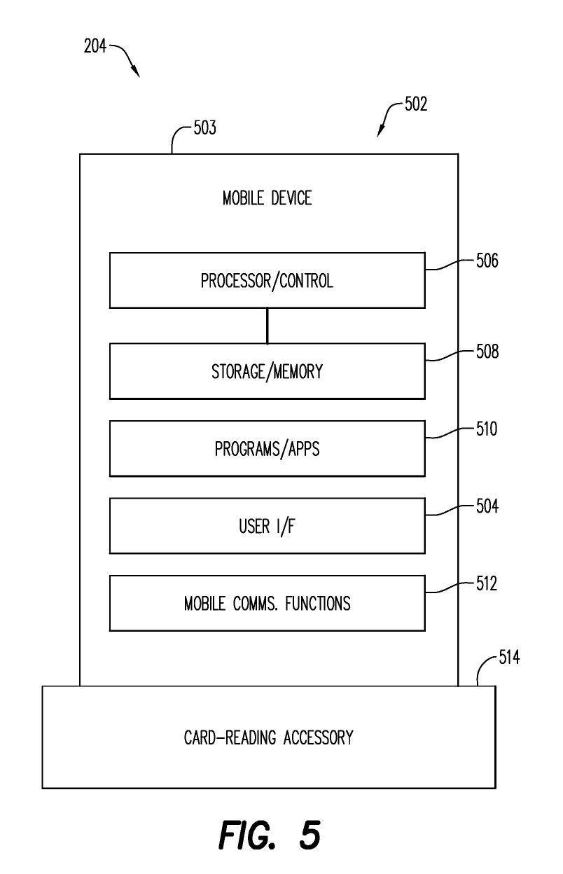

FIG. 5 is a block diagram that illustrates an example embodiment of the merchant device 204. In the embodiment shown in FIG. 4, it is assumed that the merchant device is constituted by a suitably programmed and accessorized mobile device such as a smartphone 502.

In one embodiment, the merchant device 204 may have a typical configuration and characteristics of a smartphone in its hardware aspects and also in many of its software aspects, except that the merchant device 204 may be programmed suitably to allow it to perform many, or even all, of the functions commonly expected of a POS device. Moreover, the merchant device 204 may be programmed to support two-party transaction processes as described herein.

The merchant device 204 may include a housing 503. In many embodiments, the front of the housing 503 is predominantly constituted by a touchscreen (not separately shown), which is a key element of the user interface 504 of the merchant device 204.

The merchant device 204 further includes a mobile processor/control circuit 506, which is contained within the housing 503. Also included in the merchant device 204 is a storage/memory device or devices (reference numeral 508). The storage/memory devices 508 are in communication with the processor/control circuit 506 and may contain program instructions to control the processor/control circuit to manage and perform various functions of the merchant device 204. As is well-known, a device such as smartphone 502 may function as what is in effect a pocket-sized personal computer, via programming with a number of application programs, or “apps”, as well as a mobile operating system (OS). (The apps are represented at block 510 in FIG. 5, and may, along with other programs, in practice be stored in block 508, to program the processor/control circuit 506.) Assuming that mobile communications functions are enabled in the merchant device 204, those functions are represented by block 512.

In addition, a card-reader accessory 514 may be installed so as to be operatively coupled to the mobile processor 506. The card-reader accessory 514 may be configured to provide for contact and/or contactless data communication interfacing with payment cards/devices such as the payment card 202 referred to above.

From the foregoing discussion, it will be appreciated that the blocks depicted in FIG. 5 as components of the merchant device 204 may in effect overlap with each other, and/or there may be functional connections among the blocks which are not explicitly shown in the drawing. It may also be assumed that, like a typical smartphone, the merchant device 204 may include a rechargeable battery (not shown) that is contained within the housing 503 and that provides electrical power to the active components of the merchant device 204.

In some environments, even where the merchant's place of business is not connected to an electrical power transmission grid, the merchant may nevertheless have access to a battery charging functionality (e.g., a hand-cranked battery charger) so that the merchant device 204 is practically operable in places that are without centrally-supplied electrical power.

It has been posited that the merchant device 204 may be embodied as a smartphone, but this assumption is not intended to be limiting, as the merchant device 204 may alternatively, in at least some cases, be constituted by a tablet computer or by other types of mobile computing devices. In other embodiments, the merchant device 204 may not be based on a mobile device but may be a simplified version of widely used POS devices, e.g., a version suitable for running on battery power. In still other embodiments, the merchant device may be a largely conventional POS device, programmed to provide functionality as described herein.

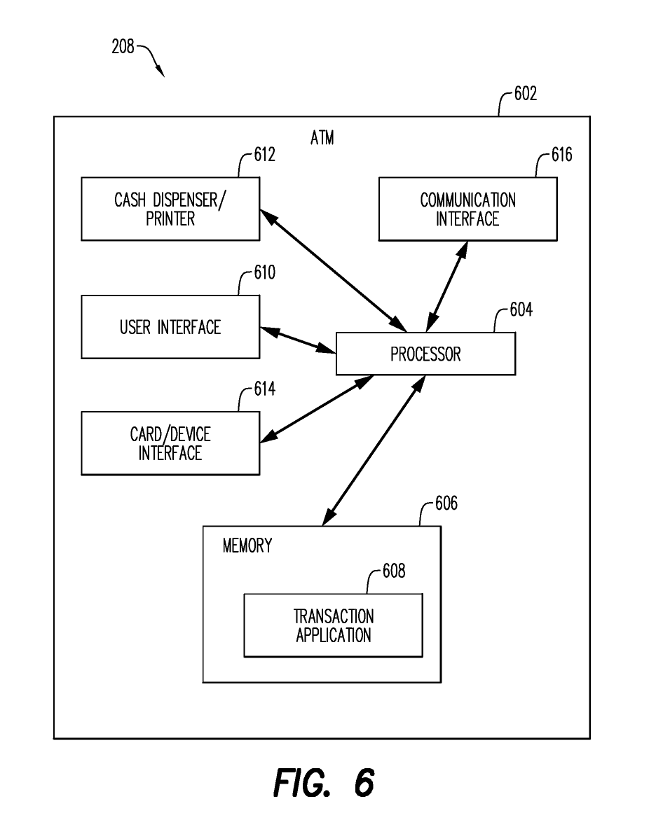

FIG. 6 is a block diagram that illustrates an example embodiment of the ATM 208.

The ATM 208 may include a housing 602 that contains and/or supports other components of the ATM 208, as described below.

The ATM 208 may also include a processor 604. The processor 604 may serve as a central control element for the ATM 208 and may control other elements of the ATM 208 including electronic, electrical and electro-mechanical elements of the ATM 208. Elements of the types just listed will be described below. The processor 604 may, for example, be a programmable microprocessor.

The ATM 208 may further include a memory device 606. The memory 606 may be in communication with the processor 604. The memory 606 may store program instructions that program the processor 604 to control the ATM 208 and to provide desired functionality, including functions as described herein. The program instructions may, among other types of instructions, include a transaction application program as indicated by block 608 in FIG. 6.

Still further, the ATM 208 may include a user interface 610. The user interface 610 may be operatively coupled to the processor 604 and may provide input/output functions with respect to the processor 604. In example embodiments, the user interface may include several constituent elements (not separately shown), including for example a touchscreen, such as is frequently incorporated in typical ATMs.

In addition, the ATM 208 may include such typically provided electromechanical elements as a cash (paper currency) dispenser and a receipt printer, both of which are represented by block 612 in FIG. 6.

Of particular pertinence to the present disclosure, the ATM 208 may also include an interface 614 for coupling by contact or contactless techniques to a payment card or device such as the IC payment card 202 described above. The card/device interface 614 is operatively coupled to the processor 604 for data communication purposes and operates to permit data communications to take place between the processor 604 and a payment card/device (not shown in FIG. 6) that has been interfaced to the card/device interface 614. Among other features, the card/device interface 614 may be equipped to furnish electrical power to a payment card/device interfaced thereto.

Also of particular pertinence, the ATM 208 may further include a communication interface 616. The communication interface 616 may be operatively coupled to the processor 604 and may be configured to enable data communication between the processor 604 and a remote computing device (not shown in FIG. 6), such as the user's bank's computer 212 shown in FIG. 2.

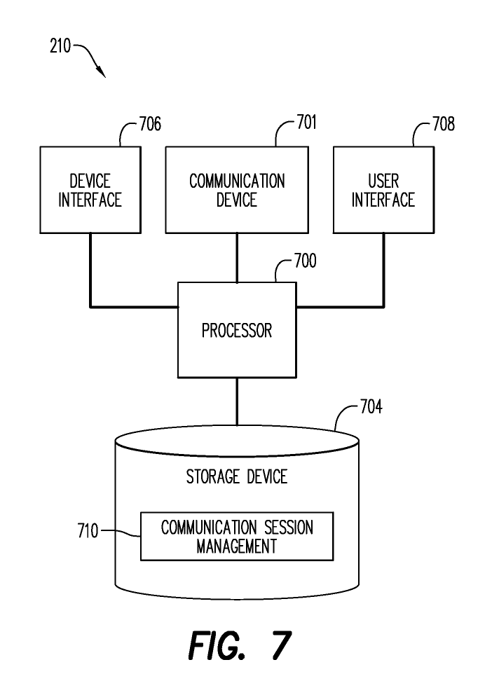

FIG. 7 is a simplified block diagram that represents an example embodiment of the network terminal 210.

To a considerable extent, the network terminal 210 may exhibit a hardware architecture typical of a computer or computing device and may be controlled by software to cause it to operate in accordance with aspects of the present disclosure.

The network terminal 210 may include a computer processor 700 operatively coupled to a communication device 701, a storage device 704, a device interface 706 and a user interface 708. The storage device 704, the communication device 701, the device interface 706 and the user interface 708 may all be in communication with the processor 700.

The computer processor 700 may be constituted by one or more single or multiple core processors or processing units. Processor 700 operates to execute processor-executable steps, contained in program instructions described below, so as to control the network terminal 210 to provide desired functionality as described herein.

Communication device 701 may be used to facilitate communication with, for example, other devices (such as a merchant's bank's computer 216). Communication device 701 may be capable of engaging in data communication over typical computer-to-computer data networks.

The user interface 708 may comprise one or more of any type of user-facing peripheral device typically used to input data into a computing device. For example, the user interface 708 may include a touchscreen and/or a keypad and/or a set of operating buttons and/or a non-touchscreen display. The device interface 706 may include electrical contacts and associated signal transmission/reception circuitry and/or a wireless communication arrangement and associated transceiver circuitry and/or any other arrangement to allow for short- or long-range communication between a merchant device 204 and the network terminal 210.

Storage device 704 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory.

Storage device 704 stores one or more programs for controlling processor 700. The programs comprise program instructions that contain processor-executable process steps of network terminal 210, including, for example, process steps that constitute processes provided to allow the network terminal 210 to serve as an interface for a data communication session between the merchant device 204 and the merchant's bank's computer 216. An application program to implement such functionality is indicated by block 710 in FIG. 7.

In addition to the communication session management software program 710, the programs stored in the storage device 704 may include one or more conventional operating systems (not shown) that control the processor 700 so as to manage and coordinate activities and sharing of resources in the network terminal 210, and to serve as a host for application programs that run on the network terminal 210. The network terminal 210 may run other software programs besides those explicitly mentioned above, including for example data communication software.

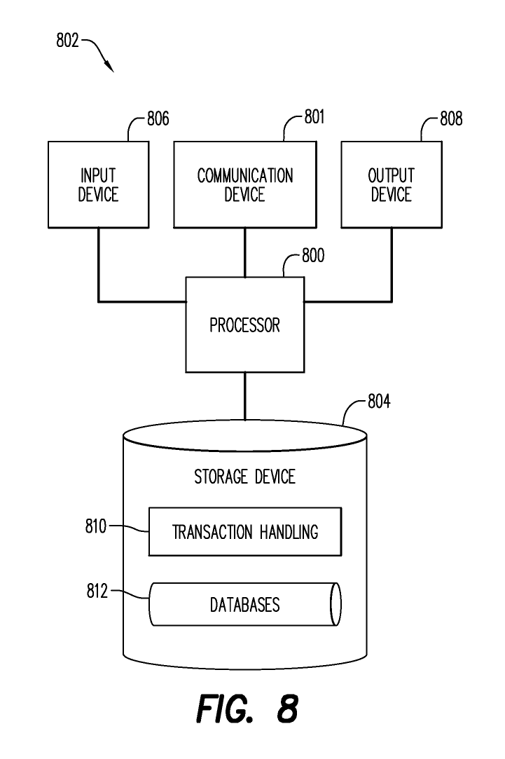

FIG. 8 is a block diagram that illustrates a typical hardware architecture for one or more computers that may be included in the payment system of FIG. 2. In particular, the typical computer illustrated in FIG. 8 will hereafter be referred to as a “constituent computer” and is indicated generally in FIG. 8 with reference numeral 802. The constituent computer 802, at least in terms of its hardware architecture and at least some of its software aspects may be taken to represent an example embodiment of any one or more of the user's bank's computer 212, the merchant's bank's computer 216 and/or a computer that implements functions of the clearing system 218. The constituent computer 802 may be constituted by server computer and/or mainframe computer hardware.

The constituent computer 802 may include a computer processor 800 operatively coupled to a communication device 801, a storage device 804, an input device 806 and an output device 808. The computer processor 800 may be in communication with the communication device 801, the storage device 804, the input device 806 and the output device 808.

The computer processor 800 may be constituted by one or more processors. Processor 800 operates to execute processor-executable steps, contained in program instructions described below, so as to control the constituent computer 802 to provide desired functionality.

Communication device 801 may be used to facilitate communication with, for example, other devices (such as other components of the payment system 200). For example communication device 801 may comprise numerous communication ports (not separately shown), to allow the constituent computer 802 to communicate simultaneously with a number of other devices and computers, including communications as required to receive and assist with and/or handle numerous transactions being reported or cleared in the payment system 200.

Input device 806 may comprise one or more of any type of peripheral device typically used to input data into a computer. For example, the input device 806 may include a keyboard and a mouse. Output device 808 may comprise, for example, a display and/or a printer.

Storage device 804 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 804 stores one or more programs for controlling processor 800. The programs comprise program instructions (which may be referred to as computer readable program code means) that contain processor-executable process steps of the constituent computer 802, executed by the processor 800 to cause the constituent computer 802 to function in accordance with its role in the payment system 200. Functionality of one or more components of the payment system 200 is described below in connection with flow charts discussed hereinafter.

The programs stored by the storage device 804 may include one or more operating systems (not shown) that control the processor 800 so as to manage and coordinate activities and sharing of resources in the constituent computer 802, and to serve as a host for application programs that run on the constituent computer 802.

One program stored in the storage device 804 may be an application program 810 that programs the constituent computer 802 to perform its assigned function or functions in handling and/or clearing specific transactions. Details of such transaction handling functionality will be described below.

The storage device 804 may further store database management programs and a reporting application (both not separately shown), the latter of which may respond to requests from system administrators for reports on the activities performed by the constituent computer 802; the storage device 804 may also store communication software, device drivers, etc.

The storage device 804 may also store one or more databases 812 required for operation of the constituent computer 802.

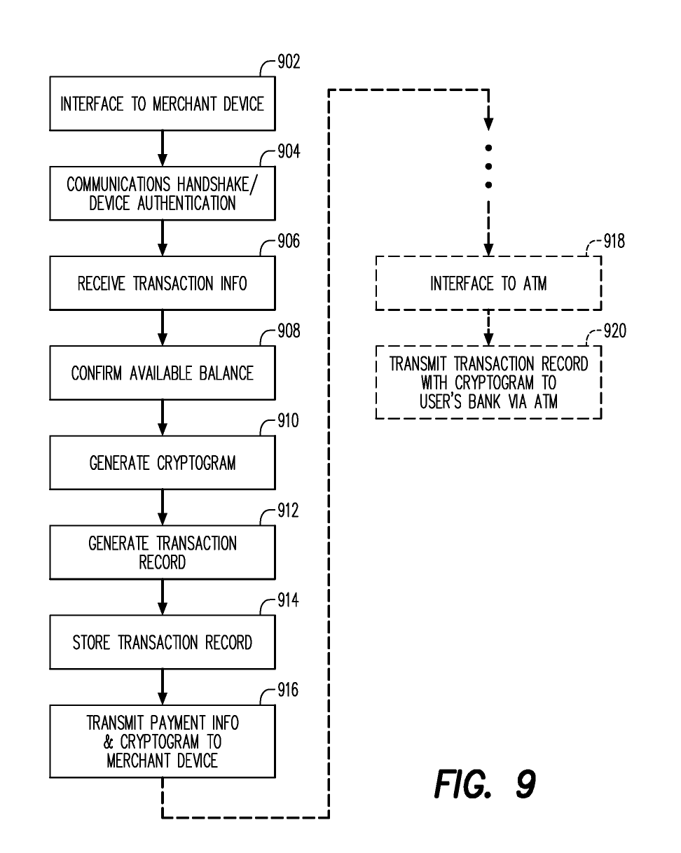

FIG. 9 is a flow chart that illustrates a process that may be performed in the payment system 200 to implement a two-party transaction model, according to some embodiments. FIG. 9 is particularly illustrative of functions performed with, or from the point of view of, the payment card/device 202.

At 902, the payment card/device 202 is interfaced to the merchant device 204. This may be done, for example, in such a manner as to allow the merchant device 204 to supply electrical power to the payment card/device 202. This may also involve juxtaposing the payment card/device 202 with the merchant device 204 in such a manner that data communications (via contact and/or contactless communication channel(s)) may take place between the payment card/device 202 and the merchant device 204. This may occur at the merchant's place of business or at another location. (I.e., in some embodiments, the merchant may be itinerant, and may sell items door-to-door, or the like.)

At 904, a communication handshake and mutual authentication process may take place between the payment card/device 202 and the merchant device 204. This may occur in accordance with known principles for facilitating payment transactions at the point of sale. For example, a standard payment transaction protocol may be invoked, such as the well-known EMV transaction protocol.

At 906, the payment card/device 202 receives transaction information from the merchant device 204. The transaction information may include a transaction total amount due, a unique identifier for the merchant device 204 and/or for the merchant that operates the merchant device 204, a transaction identifier and/or a transaction counter value, etc. As will be understood by those who are familiar with point of sale transactions, the merchant device 204 may have calculated the total amount due for the transaction based on information fed into or acquired by the merchant device 204 with respect to one or more product items that the user (of the payment card/device 202) is purchasing in the transaction. For example, the merchant device 204 may include a camera (not shown) or other scanning mechanism (not shown) to permit the merchant device to read product codes from the item(s) selected for purchase by the customer/user of the payment card/device 202. In other embodiments or in other situations, the merchant may manually enter transaction data into the merchant device 204. For example, perhaps at a minimum, the merchant may enter the total amount due for the transaction.

In some embodiments, and as indicated at 908 in FIG. 9, the payment card/device 202 may compare the transaction amount due with an available balance figure that may be stored in the payment card/device 202 to confirm that the transaction amount does not exceed the available balance. In other embodiments, no available balance figure is maintained in the payment card/device 202. If this step 908 is applicable, the transaction may be aborted if the transaction amount exceeds the available balance.

Assuming the transaction is not aborted, block 910 may follow. At block 910, the payment card/device 202 may generate a cryptogram. This may involve applying a cryptographic processing algorithm to inputs that may include some or all of the transaction information provided by the merchant device 204 at block 906. For example, the cryptogram may be based at least in part by cryptographically processing the transaction counter value and/or transaction identifier provided by the merchant device 204 for the current transaction. The payment card/device 202 may, for example, generate the cryptogram in a manner consistent with the principles of the EMV transaction protocol or according to another standard transaction processing protocol.

At 912, the payment card/device 202 may generate a transaction record for the current transaction. The transaction record may include the cryptogram that was generated at 910. The transaction record may further include at least some of the transaction information provided by the merchant device 204 at 906. For example, the transaction record may include some or all of the inputs used in the cryptographic processing by which the cryptogram was generated at 912. The transaction record may include additional information, such as the date and time of the transaction (if not already included in the transaction information provided by the merchant device 204).

At 914, the payment card/device 202 may store the transaction record generated at 912. At the same time, if applicable, the payment card/device 202 may decrease the available balance, if such is maintained in the payment card/device 202, to reflect the expenditure of the transaction amount.

At 916, the payment card/device 202 may transmit information to the merchant device 204 to complete the processing for the transaction required on the present occasion from the payment card/device 202. The information transmitted at 916 may include, for example, payment information (PAN or payment token, account/token expiration date, etc.) as well as the cryptogram generated at 910. From the user's point of view, what may occur next is that he/she is permitted to depart from the merchant's presence with the items purchased in the transaction.

At some point in time after completion of the two-party transaction (e.g., on a second occasion later in time than the occasion of the transaction, and possibly at a location that is some distance removed from the location where the transaction took place), the payment card/device 202 may report the transaction to the user's bank 212 in process steps represented at 918 and 920 in FIG. 9.

At 918, the payment card/device 202 may be interfaced to the ATM 208, so that data communications can occur between the payment card/device 202 and the user's bank's computer 212.

At 920, the payment card/device 202 may transmit, to the user's bank's computer 212, via the ATM 208, at least some of the transaction record generated at 912 and stored in the payment card/device 202 at 914. The information transmitted by the payment card/device 202 at 920 may include the cryptogram generated at 910. It will be appreciated that as part of the transaction reporting process, the payment card/device 202 may identify itself and/or the user's payment account to the user's bank 212. As will be seen, with the transaction having been reported to the user's bank 212 from the payment card/device 202, it may then be cleared between the user's account and the merchant's account.

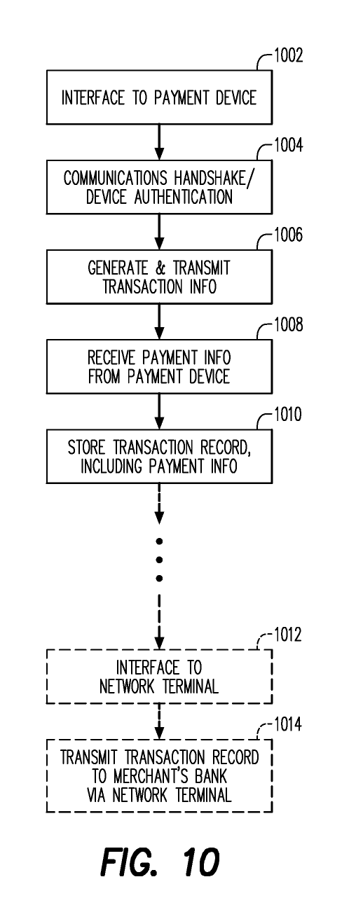

FIG. 10 is a flow chart that illustrates a further process that may be performed in the payment system 200 to implement a two-party transaction model, according to some embodiments. FIG. 10 is particularly illustrative of functions performed with, or from the point of view of, the merchant device 204.

At 1002, the merchant device 204 is interfaced to the payment card/device 202 to enable data communication therebetween. This is the mirror image of the process step described above in connection with block 902 in FIG. 9, and the description of block 902 generally is applicable.

At 1004, there is a communications handshake and mutual authentication, as in the above-described step 904 of FIG. 9.

At 1006, the merchant device 204 generates and transmits (to the payment card/device 202) the transaction information as described above in connection with the receipt of transaction information by the payment card/device 202 in block 906 of FIG. 9.

At 1008, the merchant device 204 receives, from the payment card/device 202, the payment information referred to above in connection with block 916. The payment information may include the cryptogram generated by the payment card/device 202 as described above in connection with block 910. The payment information may also include all information used as inputs to the generation of the cryptogram, at least to the extent that such information is not already in the possession of the merchant device 204.

At 1010 in FIG. 10, the merchant device 204 may store a transaction record for the current transaction, including the cryptogram and other information (including payment information) received from the payment card/device 202 at 1008.

At some point in time after completion of the two-party transaction (e.g., on a second occasion later in time than the occasion of the transaction, and possibly at a location that is some distance removed from the location where the transaction took place), the merchant device 204 may report the transaction to the merchant's bank 216 in process steps represented at 1012 and 1014 in FIG. 10.

At 1012, the merchant device 204 may be interfaced to the network terminal 210, so that data communications can occur between the merchant device 204 and the merchant's bank's computer 216.

At 1014, the merchant device 204 may transmit, to the merchant's bank's computer 216, via the network terminal 210, at least some of the transaction record stored by the merchant device 204 at 1010. The information transmitted by the merchant device 204 at 1014 may include the cryptogram received from the payment card/device 202 by the merchant device 204 at 1008. As part of the transaction reporting process, the merchant device 204 may identify itself, and/or the merchant, and/or the merchant's account to the merchant's bank 216.

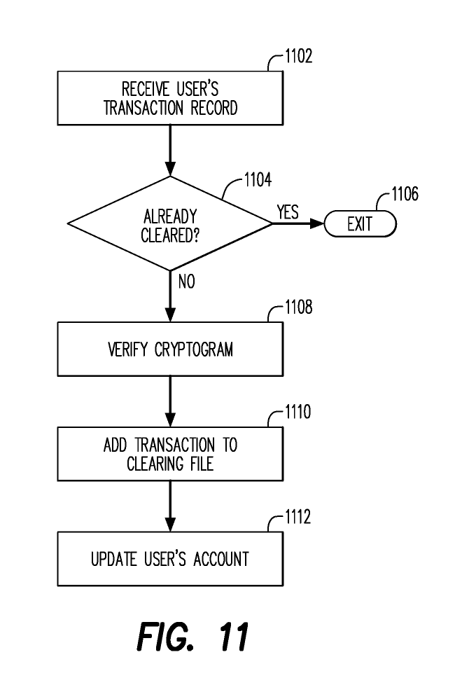

FIG. 11 is a flow chart that illustrates still another process that may be performed in the payment system 200 to implement a two-party transaction model, according to some embodiments. FIG. 11 is particularly illustrative of functions performed with, or from the point of view of, the user's bank's computer 212.

At 1102 in FIG. 11, user's bank's computer 212 receives a transaction record from a payment card/device 202. This step corresponds to the transmitting of the transaction record from the payment card/device 202 as described above in connection block 920 in FIG. 9.

A decision block 1104 may follow block 1102. At decision block 1104, the user's bank's computer 212 may determine whether the transaction reported at 1102 has already been cleared through the payment system 200 (and thus has previously been charged to the user's account; this may occur if the merchant had reported the transaction prior to the time when the payment card/device 202 reported the transaction to the user's bank's computer 212). If a positive determination is made at 1104 (i.e., if the transaction was previously cleared), then the process may exit, as indicated at 1106.

However, if a negative determination is made at 1104 (i.e., if the transaction was not previously cleared), then block 1108 may follow decision block 1104. At block 1108, the user's bank's computer 212 may verify the cryptogram that may have been received from the payment card/device 202 at block 1102. In order to verify the cryptogram, the user's bank's computer 212 may duplicate the cryptographic process performed by the payment card/device 202 in generating the cryptogram, based on the same inputs to that process as used by the payment card/device 202. The user's bank's computer 212 may then compare the result of its cryptographic process with the cryptogram it received. If the result produced by the bank computer's cryptographic process matches the received cryptogram, the cryptogram may be deemed to have been verified.

Based on a result of the verification step 1108 (i.e., if the cryptogram was verified), then the user's bank's computer 212 may add the transaction in question to a clearing file, as indicated at block 1110 in FIG. 11. Due to the addition of the transaction to the clearing file, the transaction is included in a clearing process, coordinated through the clearing system 218 (FIG. 2), such that the transaction is cleared from the user's account to the merchant's account. The user's bank's computer 212 then updates the user's account to reflect the transaction, as indicated at 1112 in FIG. 11.

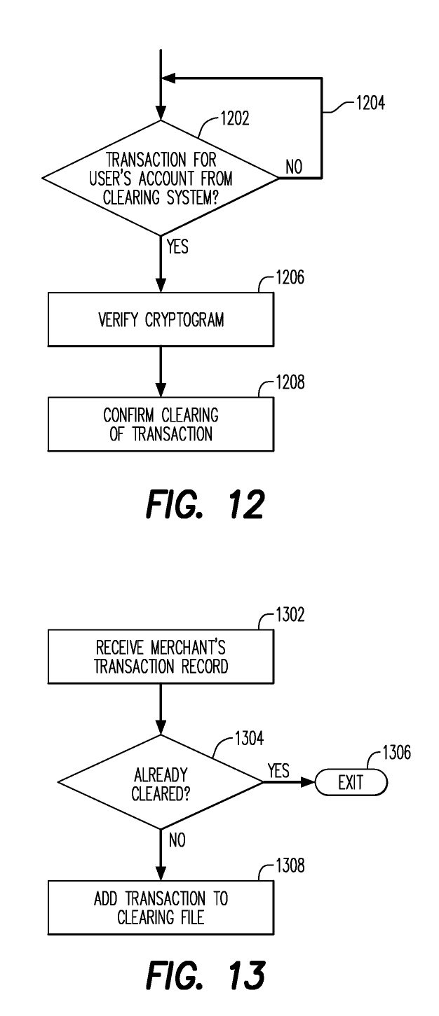

FIG. 12 is a flow chart that illustrates still another process that may be performed in the payment system 200 to implement a two-party transaction model, according to some embodiments. FIG. 12 is particularly illustrative of functions performed with, or from the point of view of, the user's bank's computer 212.

At a decision block 1202 in FIG. 12, the user's bank's computer 212 may determine whether it has received a transaction for clearing to the user's account from the clearing system 218. Until such a transaction is received, the process may idle through the “no” branch 1204 from the decision block 1202.

If a positive determination is made at decision block 1202 (i.e., if the user's bank's computer 212 determines that it has received a transaction for the user's account via the clearing system 218), then block 1206 may follow decision block 1202.

At block 1206, the user's bank's computer 212 may verify a cryptogram that was included in the transaction information received by the user's bank's computer 212 via the clearing system. The process of block 1206 may resemble the process described above with respect to block 1108 of FIG. 11, except that—with respect to the process of block 1206, the cryptogram and other information required for verification of the cryptogram may be received by the user's bank's computer 212 via the clearing system 218 rather than from the payment card/device 202, as was the case with respect to the process of block 1108.

Based on a result of block 1206 (i.e., if the cryptogram is verified), then block 1208 follows in the process of FIG. 12. At 1208, the user's bank's computer 212 may signal to the clearing system 218 that the clearing of the transaction is confirmed. It will be appreciated that this may result in the transaction being charged to the user's account at the user's bank.

FIG. 13 is a flow chart that illustrates a further process that may be performed in the payment system 200 to implement a two-party transaction model, according to some embodiments. FIG. 13 is particularly illustrative of functions performed with, or from the point of view of, the merchant's bank's computer 216.

At 1302 in FIG. 13, the merchant's bank's computer 216 may receive a transaction record from the merchant device 204. This may correspond to the transmission of the transaction record by the merchant device 204 as described above in connection with block 1014 of FIG. 10.

A decision block 1304 may follow block 1302. At decision block 1304, the merchant's bank's computer 216 may determine whether the transaction reported at 1102 has already been cleared through the payment system 200 (this may occur if the user had reported the transaction prior to the time when the merchant device 204 reported the transaction to the merchant's bank's computer 216). If a positive determination is made at 1304 (i.e., if the transaction was previously cleared), then the process may exit, as indicated at 1306.

However, if a negative determination is made at 1304 (i.e., if the transaction was not previously cleared), then block 1308 may follow decision block 1304. At block 1308, the merchant's bank's computer 216 may add the transaction in question to a clearing file. Due to the addition of the transaction to the clearing file, the transaction is included in a clearing process, coordinated through the clearing system 218 (FIG. 2), such that the transaction is cleared from the user's account to the merchant's account.

A payment system according to some embodiments, such as that illustrated in FIG. 2, may support transactions according to a two-party model, such that modern, cashless payment transaction techniques may be feasible at the point of sale in operating environments where up to now cash has predominantly been used. The transaction model provided according to some embodiments may work well even in the absence of reliable data communication connectivity or electrical power supply. The advantages of payment account transactions, with a two-party model as described herein, may be extended from current geographical regions where there is widespread payment account acceptance to penetrate numerous additional regions, thereby increasing the overall usefulness and reach of payment systems and facilitating commerce in many relatively low-income countries or regions. With the payment system described according to the present disclosure, merchants may gain opportunities for additional sales, including sales on occasions when the customer lacks the cash that would otherwise be needed for the transaction. The payment system described herein for facilitating two-party transaction processes may also reduce the need for consumers to carry cash in less developed regions. The two-party model described herein may also allow for savings on payment network infrastructure and/or usage, and may promote a low-cost manner of extending the market for payment accounts.

In the two-party model payment system of FIG. 2, it was assumed that the payment account holder and the merchant were served by two different banks. However, this need not necessarily be the case. In some situations or in some embodiments, the payment account holder and the merchant may be served by the same bank or payment services provider. Where the system is an “open loop” system, with a considerable number of account issuers, an “on-us” transaction may occur rather than the interbank clearing described above, if the payment account holder's bank is the same as the merchant's bank. In other embodiments, a closed loop system may be implemented, with only a single issuer of accounts (financial institution, postal authority, payment services provider, telecommunications provider, etc., for example), but with either the account holder mobile device or the merchant device reporting transactions to the single account issuer, generally as described above in connection with FIGS. 9 and 10.

In example embodiments described above, the account holder's reporting of transactions was via interfacing the payment card/device to an ATM. However, in other embodiments or other situations, there may be other modes of putting the payment card/device in communication with the account holder's bank. For example, a terminal that is not an ATM may be employed for this purpose. Where the payment device is a payment-enabled smartphone or the like, offline reporting “over the air” may occur.

Similarly, in the case of the merchant reporting of transactions, a network terminal such as that described above is not the only possible way for a merchant device to be put in communication with the merchant's bank. Among other possibilities, again offline over the air reporting may occur. In some embodiments, for example, the merchant device may include a removable memory element that the merchant may interface to a suitable terminal for the purpose of reporting transactions to the merchant's bank.

As used herein and in the appended claims, the term “payment device” includes but is not limited to payment cards. Payment-enabled mobile devices are also included within the meaning of “payment device”.

As used herein and in the appended claims, the term “network device” includes but is not limited to an ATM.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather, the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment system” refers to a system for handling purchase transactions and related transactions. An example of such a system is the one operated by MasterCard International Incorporated, the assignee of the present disclosure. In some embodiments, the term “payment system” may be limited to systems in which member financial institutions issue payment accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method of operating a payment device, the method comprising:
interfacing the payment device to a merchant device on a first occasion to perform a payment transaction, the payment device creating and storing a record of the payment transaction during the first occasion, the payment device storing an available balance amount;
interfacing the payment device to a network device on a second occasion subsequent to the first occasion; and
during the interfacing of the payment device to the network device, transmitting at least a portion of the record of the payment transaction from the payment device to the network device to cause the payment transaction to be cleared from a first account to a second account, the first account belonging to a user of the payment device, the second account belonging to a merchant that operates the merchant device, the available balance amount being updated during the interfacing of the payment device to the network device.

2. The method of claim 1, wherein:
the payment device generates a cryptogram while creating the record of the payment transaction, the cryptogram stored by the payment device as part of the record of the payment transaction, the cryptogram transmitted from the payment device to the network device during the second occasion.

3. The method of claim 2, wherein:
the record of the payment transaction includes: (a) a merchant identifier received by the payment device from the merchant device on the first occasion; (b) a transaction identifier generated on the first occasion; and (c) a transaction counter value that corresponds to the payment transaction; and
the payment device generates the cryptogram by a cryptographic process, the cryptographic process having inputs that include: (i) the merchant identifier; (ii) the transaction identifier; (iii) the transaction counter value; and (iv) an account identifier that corresponds to said first account.

4. The method of claim 3, wherein:
the record of the payment transaction includes a transaction amount received by the payment device from the merchant device on the first occasion; and
the transaction amount is transmitted from the payment device to the network device on the second occasion.

5. The method of claim 4, wherein:
on the first occasion, the payment device confirms that the transaction amount does not exceed an available balance amount stored and maintained in the payment device prior to the first occasion.

6. The method of claim 1, wherein the payment device is an integrated circuit (IC) payment card.

7. The method of claim 1, wherein the payment device is a payment-enabled mobile device.

8. The method of claim 1, wherein the network device is an ATM (automated teller machine).

9. A payment device, comprising:
a processor; and
a memory in communication with the processor, the memory storing program instructions, the processor operative with the program instructions to perform functions as follows:
engaging in data communications with a merchant device on a first occasion to perform a payment transaction;
creating and storing a record of the payment transaction during the first occasion;
engaging in data communications with a network device on a second occasion subsequent to the first occasion; and
during the data communications with the network device, transmitting at least a portion of the record of the payment transaction to the network device to cause the payment transaction to be cleared from a first account to a second account, the first account belonging to a user of the payment device, the second account belonging to a merchant that operates the merchant device, the payment device storing an available balance amount, the available balance amount being updated during the data communication with the network device.

10. The payment device of claim 9, wherein the processor is further operative with the program instructions to:
generate a cryptogram while creating the record of the payment transaction, the cryptogram stored as part of the record of the payment transaction, the cryptogram transmitted to the network device during the second occasion.

11. The payment device of claim 10, wherein:
the record of the payment transaction includes: (a) a merchant identifier received from the merchant device on the first occasion; (b) a transaction identifier generated on the first occasion; and (c) a transaction counter value that corresponds to the payment transaction; and
the cryptogram is generated by performing a cryptographic process, the cryptographic process having inputs that include: (i) the merchant identifier; (ii) the transaction identifier; (iii) the transaction counter value; and (iv) an account identifier that corresponds to said first account.

12. The payment device of claim 11, wherein:
the record of the payment transaction includes a transaction amount from the merchant device on the first occasion; and
the transaction amount is transmitted to the network device on the second occasion.

13. The payment device of claim 12, wherein the processor is further operative with the program instructions to:
on the first occasion, confirm that the transaction amount does not exceed an available balance amount stored and maintained in the payment device prior to the first occasion.

14. The payment device of claim 9, further comprising a card-shaped body that supports the processor and the memory.

15. A storage device storing program instructions for controlling a payment device, the program instructions including:
instructions for facilitating data communications between the payment device and a merchant device on a first occasion to perform a payment transaction, and for controlling the payment device to create and store a record of the payment transaction during the first occasion;
instructions for facilitating data communications between payment device and a network device on a second occasion subsequent to the first occasion; and
instructions for controlling the payment device, on the second occasion, to transmit at least a portion of the record of the payment transaction to the network device to cause the payment transaction to be cleared from a first account to a second account, the first account belonging to a user of the payment device, the second account belonging to a merchant that operates the merchant device, the payment device storing an available balance amount, the available balance amount being updated during the communication between the payment device and the network device.

16. The storage device of claim 15, further comprising:
instructions for generating a cryptogram while creating the record of the payment transaction, the cryptogram stored by the payment device as part of the record of the payment transaction, the cryptogram transmitted from the payment device to the network device during the second occasion.

17. The storage device of claim 16, wherein:
the record of the payment transaction includes: (a) a merchant identifier received by the payment device from the merchant device on the first occasion; (b) a transaction identifier generated on the first occasion; and (c) a transaction counter value that corresponds to the payment transaction; and
the cryptogram generated by a cryptographic process, the cryptographic process having inputs that include: (i) the merchant identifier; (ii) the transaction identifier; (iii) the transaction counter value; and (iv) an account identifier that corresponds to said first account.

18. The storage device of claim 17, wherein:
the record of the payment transaction includes a transaction amount received by the payment device from the merchant device on the first occasion; and
the transaction amount is transmitted from the payment device to the network device on the second occasion.

19. The storage device of claim 18, further comprising:
instructions for confirming, on the first occasion, that the transaction amount does not exceed an available balance amount stored and maintained in the payment device prior to the first occasion.

20. The storage device of claim 15, wherein the storage device is incorporated in an integrated circuit (IC) payment card.

21. A network device, comprising:
a processor; and
a memory in communication with the processor, the memory storing program instructions, the processor operative with the program instructions to perform functions as follows:
engaging in a transmission transaction in which a first device is interfaced to the network device, the first device reporting, during the transmission transaction, a purchase transaction that occurred between the first device and a second device, the purchase transaction having occurred on an occasion prior to the transmission transaction; and
uploading data concerning the purchase transaction to a financial institution during the transmission transaction to cause the purchase transaction to be cleared.

22. The network device of claim 21, wherein the first device is a payment device and the second device is a merchant device.

23. The network device of claim 21, wherein the first device is a merchant device and the second device is a payment device.
